(19) United States
(12) Patent Application Publication
(10) Pub. No.: US 2026/0235283 A1
(43) Pub. Date: Aug. 13, 2026

(54) LED LIGHTING APPARATUS

(71) Applicant: BAELUX CO., LTD., Seoul (KR)

(72) Inventor: Jinwoo BAE, Seoul (KR)

(73) Assignee: BAELUX CO., LTD., Seoul (KR)

(21) Appl. No.: 19/423,357

(22) Filed: Dec. 17, 2025

(30) Foreign Application Priority Data
Feb. 11, 2025 (KR) 10-2025-0017610
Sep. 3, 2025 (KR) 10-2025-0125014

(51) Int. Cl. F21V 23/06; F21V 7/05; F21V 19/00; F21Y 105/16; F21Y 115/10

(52) U.S. Cl. CPC F21V 23/06; F21V 7/05; F21V 19/0035; F21Y 2105/16; F21Y 2115/10

(57) ABSTRACT

The present disclosure relates to an LED lighting apparatus. The LED lighting apparatus includes a luminaire housing forming a mounting surface; a connecting board configured to be electrically connectable to an external power source and fixed to the luminaire housing; and a plurality of LED modules fixed to the luminaire housing in a state of being electrically connected to the connecting board, each of the LED modules including an LED light source. The connecting board and the LED modules are disposed on the same plane with respect to the mounting surface.

### CROSS-REFERENCE TO RELATED APPLICATIONS

This application claims priorities to Korean Patent Application No. 10-2025-0017610 filed February 11, 2025 and Korean Patent Application No. 10-2025-0125014 filed September 3, 2025, the entire disclosures of which are incorporated by reference herein.

### TECHNICAL FIELD

The present disclosure relates to an LED lighting apparatus.

### BACKGROUND

In general, an LED lighting apparatus mounted on a ceiling includes a luminaire housing, and an LED module installed in the luminaire housing and on which LED elements are mounted. In such an LED lighting apparatus, in consideration of product cost and efficiency, it is desirable to reduce the number of LED elements and LED modules as much as possible, and as a result, empty spaces are formed between the LED elements. The empty spaces between the LED elements form dark regions, thereby degrading light uniformity and also causing a reduction in efficiency.

In order to address these problems, there have been proposed methods of applying a reflective coating to the luminaire housing or installing a reflector therein; however, such methods have limitations in improving reflective efficiency and are accompanied by problems such as manufacturing difficulty and increased manufacturing cost.

In addition, when a wiring harness is used to supply electrical power to the LED module, it is disadvantageous in terms of structural configuration, and also causes problems such as increased complexity of the manufacturing process and increased manufacturing cost. Further, when the LED module is disposed away from an edge of a mounting surface of the luminaire housing in order to apply a structure for supplying electrical power to the LED module, dark regions may be formed at the edge, which can result in degradation of light uniformity and efficiency.

In addition, in order to enhance the light efficiency and uniformity of a lighting apparatus, a reflective sheet is sometimes applied. In general, a method is used in which an LED module is first installed, and then a reflective sheet including a plurality of escape holes for exposing all LED light sources is installed on the LED module. When such a reflective sheet having this structure is used, fabrication and installation of the reflective sheet are difficult, and an adhesive layer for attaching the reflective sheet or separate fixing components are required.

The matters described in the background of the invention are provided to enhance understanding of the background of the invention and may include matters that do not constitute prior art already known in the technical field to which the invention pertains.

### SUMMARY

An object of the present invention is to provide a method capable of eliminating a separate wiring process between a plurality of LED modules spaced apart from each other through a simple structure, and enabling electrical connection to be automatically established during mechanical assembly of the LED modules, thereby minimizing an assembly process.

Another object of the present invention is to provide a structure that eliminates a separate process for attaching a reflective sheet through a simple configuration, and automatically fixes the reflective sheet during a mechanical assembly process of an LED module and an optical member, thereby minimizing an assembly process.

Still another object of the present invention is to provide a connecting board that enables elimination of a wiring process between LED modules, while allowing LED light sources to be disposed as close as possible to an edge of a luminaire housing so as to minimize formation of dark regions.

Still another object of the present invention is to provide a connecting board that enables elimination of a wiring process between LED modules, while allowing LED light sources to be disposed as close as possible to an edge of a housing and enabling a luminaire housing to have a reduced thickness.

The technical problems to be achieved by the present invention are not limited to the above-mentioned technical problems, and other technical problems not explicitly mentioned will be understood by those skilled in the art to which the present invention pertains from the following description.

An LED lighting device according to an embodiment of the present invention includes a luminaire housing forming a mounting surface; a connecting board configured to be electrically connectable to an external power source and fixed to the luminaire housing; and a plurality of LED modules each fixed to the luminaire housing in a state of being electrically connected to the connecting board and each including an LED light source. The connecting board and the LED modules are disposed on the same plane with respect to the mounting surface.

The connecting board may be arranged near an edge of the luminaire housing, and the LED modules may be arranged to extend in a direction orthogonal to a longitudinal direction of the connecting board.

The LED module may be configured such that, in a state in which the connecting board is fixed to the luminaire housing, the LED module moves in a direction orthogonal to the connecting board so that electrical connection with the connecting board and mechanical connection with the luminaire housing are simultaneously achieved.

The connecting board may be fixed to the luminaire housing by fastening elements provided on the luminaire housing. The connecting board may include a first connector for electrical connection with the LED modules, and the LED modules may include second connectors electrically connectable to the first connector. The connecting board may be configured such that a width of a first portion in which the first connector is disposed is smaller than a width of a second portion coupled with the fastening elements.

The first portion may be formed as a recessed structure in which a side opposite to an edge of the luminaire housing is recessed toward the edge of the luminaire housing.

The recessed edge of the recessed structure may be formed to be further recessed toward the edge of the luminaire housing than a distal end of the first connector.

The connecting board may include a first connector for electrical connection with the LED module, and the LED module may include a second connector electrically connectable to the first connector. The second connector may be composed of two one-pole connectors spaced apart from each other in a width direction of the LED module.

The luminaire housing may include one or more first fastening elements for fixing the connecting board, and one or more second fastening elements for fixing the LED modules. The connecting board may be fixed to the luminaire housing by being fastened to the first fastening elements, and the LED modules may be fixed to the luminaire housing by being fastened to the second fastening elements.

The connecting board may be mechanically connected to the luminaire housing by being engaged with the first fastening element through sliding on the mounting surface, and the LED module may be mechanically connected to the luminaire housing by being engaged with the second fastening element through sliding on the mounting surface.

A direction of sliding for mechanical connection between the connecting board and the luminaire housing and a direction of sliding for mechanical connection between the LED module and the luminaire housing may be orthogonal to each other. The LED module may be configured such that, when the LED module is mechanically connected to the luminaire housing by sliding, a mechanical connection between the LED module and the connecting board is simultaneously formed.

According to another embodiment of the present invention, the LED lighting device may further include a connector structure for forming electrical connection between the connecting board and the LED module. The connector structure may be configured such that mechanical connection is formed together with formation of the electrical connection, and may include a locking structure for locking and unlocking the mechanical connection.

The connecting board and the LED modules may be configured to be respectively fastened to the luminaire housing by a first fastening element and a second fastening element. The LED module may be configured such that, when the LED module is assembled to the luminaire housing by the second fastening element, a mechanical connection by the connector structure is formed. The LED module assembled to the luminaire housing by the second fastening element may be configured such that separation of the LED module from the luminaire housing is blocked by the mechanical connection of the connector structure. The connecting board temporarily assembled to the luminaire housing by the first fastening element may be configured such that separation of the connecting board from the luminaire housing is blocked by the mechanical connection of the connector structure, so that the connecting board is finally fixed to the luminaire housing.

The connector structure may include a first connector provided on the connecting board, and a second connector provided on the LED module. The locking structure may include a latch provided on one of the first and second connectors, a locking groove provided on the other one of the first and second connectors and configured to allow the latch to be inserted therein, and a release member connected to the latch and configured to be deformable by an external force so that the latch can be disengaged from the locking groove.

The latch is configured such that, when no external force is applied, the latch is inserted into the locking groove by elastic restoring force so that a locked state is maintained, and when an external force is applied to the release member, the latch is disengaged from the locking groove by deformation so as to be in an unlocked state.

The LED lighting device may further include a reflective sheet that covers the mounting surface, and the LED module may be fixed to the luminaire housing in a state of being placed on the reflective sheet. In another example, the connecting board may also be fixed to the luminaire housing in a state of being placed on the reflective sheet.

The reflective sheet may be pressed by the LED module to be fixed to the luminaire housing. In another example, the reflective sheet may be pressed by the LED module and the connecting board to be fixed to the luminaire housing.

The luminaire housing may include an inclined sidewall portion disposed around the mounting surface, and the reflective sheet may be formed to cover the mounting surface and the inclined sidewall portion.

The LED lighting device may further include an optical member that is fastened to the luminaire housing and adjusts characteristics of light emitted from the LED module. An outer portion of the reflective sheet may be configured such that an end thereof is pressed by the optical member and is fixed to the luminaire housing by the optical member when the optical member is assembled to the luminaire housing. For example, the optical member may be a member that adjusts characteristics of emitted light, such as a diffusion plate or a prism sheet.

A ratio of an area of the plurality of LED modules to the mounting surface may be smaller than a predetermined ratio.

The predetermined ratio may fall within a range of 30% to 50%.

According to the present invention, electrical connection is automatically established during mechanical assembly of a plurality of LED modules spaced apart from each other, thereby eliminating a separate wiring process between the LED modules and minimizing an assembly process.

In addition, since the connecting board and the LED module are arranged on the same plane with respect to a mounting surface of the luminaire housing, the thickness of the LED lighting apparatus can be reduced.

Further, by arranging the connecting board and the LED module on the same plane and disposing the LED module as close as possible to an edge of the luminaire housing, generation of dark regions caused by an area occupied by the connecting board can be suppressed. If the connecting board is disposed below the LED module, the luminaire housing becomes thicker, whereas if the connecting board is disposed above the LED module, light emitted from nearby LED light sources, particularly from light-directing lenses, may be blocked. According to the present invention, such problems are solved by arranging the connecting board and the LED module on the same plane, and in this case, in order to overcome an issue that the connecting board occupies a space on the same plane, a portion of the connecting board on which a connector is installed is formed to be recessed toward the edge of the luminaire housing, thereby allowing the LED module to be disposed as close as possible to the edge of the luminaire housing.

Further, according to the present invention, by installing a reflective sheet having a minimized number of perforations between the LED module and the luminaire housing without a separate attachment or fixing process, assembly and production costs can be minimized while improving light efficiency of the luminaire and eliminating dark regions.

Other various effects obtainable or expected from embodiments of the present invention are directly or implicitly disclosed in the following detailed description of the embodiments of the present invention.

### BRIEF DESCRIPTION OF THE DRAWINGS

FIG. 1 is a schematic perspective view of an LED lighting apparatus according to an embodiment of the present invention.

FIG. 2 is a plan view of a luminaire housing of the LED lighting apparatus according to an embodiment of the present invention.

FIG. 3 is a plan view of a reflective sheet of the LED lighting apparatus according to an embodiment of the present invention.

FIG. 4 is a view illustrating a connecting board and an LED module of the LED lighting apparatus according to an embodiment of the present invention.

FIG. 5 is a view illustrating a state in which a reflective sheet, a connecting board, and an LED module are assembled to a luminaire housing in an LED lighting apparatus according to an embodiment of the present invention.

FIG. 6 is a view illustrating a coupled state of a connecting board and an LED module of an LED lighting apparatus according to an embodiment of the present invention.

FIG. 7 is a view illustrating a disassembled state of a connecting board and an LED module of an LED lighting apparatus according to an embodiment of the present invention.

FIG. 8 is a cross-sectional view illustrating a state in which electrical connection between a connecting board and an LED module is established in an LED lighting apparatus according to an embodiment of the present invention.

FIG. 9 is a cross-sectional view illustrating a state in which electrical connection between a connecting board and an LED module is established in an LED lighting apparatus according to another embodiment of the present invention.

FIG. 10 is a comparative view illustrating a degree of improvement in luminous efficiency of a luminaire when reflective sheets are respectively disposed on an upper side and a lower side of an LED module.

FIG. 11 is a comparative view illustrating degrees of improvement in luminous efficiency of a luminaire in cases where reflective sheets are respectively disposed on an upper side and a lower side of an LED module, and a reflective sheet is disposed on a sidewall portion of a luminaire housing, and where the reflective sheet is not disposed on the sidewall portion.

FIG. 12 is a view illustrating a connector structure for electrical connection between an LED module and a connecting board of an LED lighting apparatus according to another embodiment of the present invention.

FIG. 13 is a view illustrating a state in which first and second connectors of the connector structure of FIG. 12 are coupled to each other.

FIG. 14 is a cross-sectional view illustrating a state in which first and second connectors of the connector structure of FIG. 12 are separated.

FIG. 15 is a cross-sectional view illustrating a state in which first and second connectors of the connector structure of FIG. 12 are coupled to each other.

FIG. 16 is a cross-sectional view illustrating a releasable state of first and second connectors of the connector structure of FIG. 12.

FIG. 17 is a plan view of a reflective sheet of an LED lighting apparatus according to another embodiment of the present invention.

FIG. 18 is a view illustrating a state in which a reflective sheet, a connecting board, and an LED module are assembled to a luminaire housing in an LED lighting apparatus according to another embodiment of the present invention.

FIG. 19 is a view illustrating a reflective sheet of an LED lighting apparatus according to another embodiment of the present invention.

### DETAILED DESCRIPTION

Hereinafter, embodiments of the present invention will be described in detail with reference to the accompanying drawings so that a person skilled in the art to which the present invention pertains can easily carry out the present invention. However, the present invention may be embodied in various different forms and is not limited to the embodiments described herein.

The terminology used herein is for the purpose of describing particular embodiments only and is not intended to limit the present invention. As used herein, the singular forms are intended to include the plural forms as well, unless the context clearly indicates otherwise. It will be further understood that the terms “comprises” and/or “comprising,” when used herein, specify the presence of stated features, integers, steps, operations, elements, and/or components, but do not preclude the presence or addition of one or more other features, integers, steps, operations, components, and/or groups thereof. The terms “coupled” or “fastened” indicate a physical relationship between two components in which the components are directly connected to each other or indirectly connected through one or more intervening components. When a component is described as being “connected,” “coupled,” or “joined” to another component, it should be understood that the component may be directly connected, coupled, or joined to the other component, or intervening components may be present between the respective components.

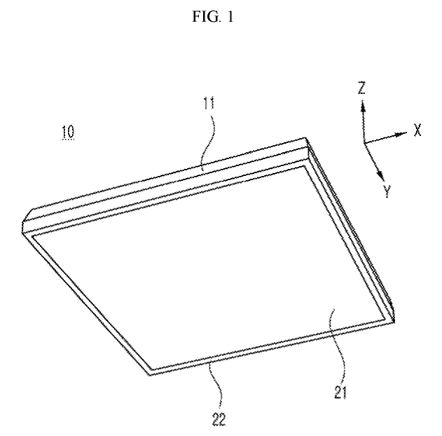

Referring to FIGS. 1 and 5, an LED lighting apparatus 10 according to an embodiment of the present invention may be a flat-type lighting apparatus configured to be installed on a ceiling. The LED lighting apparatus 10 includes a luminaire housing 11 configured to be fixed to an installation structure, for example, a T-bar of a ceiling, or to be directly attached to a ceiling surface or fixed by wires in a pendant form, a connecting board 12 fixed to the luminaire housing 11, and a plurality of LED modules 13. In addition, the LED lighting apparatus 10 may include an optical member that covers a front side of a space in which the LED modules 13 are disposed, for example, a light diffusion plate 21. The optical member is not limited thereto and may be any member capable of controlling optical characteristics, such as a prism sheet. FIG. 1 illustratively shows a state in which a bezel 22 is additionally installed together with the light diffusion plate 21.

The LED module 13 includes a PCB and a plurality of LED light sources 14 installed on the PCB. Each LED light source 14 may include an LED element and an optical member covering the LED element, for example, an optical lens such as a light-directing-angle lens. The connecting board 12 is electrically connected to an external power supply, not shown, and the plurality of LED modules 13 are respectively electrically connected to the connecting board 12. Accordingly, power from the external power supply can be supplied to the LED modules 13, thereby enabling light emission of the LED light sources 14. Although not illustrated in the drawings, the connecting board 12 may be formed of a PCB including electrical wiring for electrical connection with the LED modules 13. The LED modules 13 and the connecting board 12 may be electrically connected by connectors, and for example, the connectors may include a female connector 62 and a male connector 63 respectively provided on the connecting board 12 and the LED modules 13.

The luminaire housing 11 includes a mounting surface 16 on which the connecting board 12 and the LED modules 13 are mounted, and a reflective sheet 31 is fixed on the mounting surface 16. The connecting board 12 and the LED modules 13 may be fixed to the luminaire housing 11 in a state of being placed on the reflective sheet 31. Meanwhile, in another embodiment, the connecting board and the LED modules may be directly installed on the mounting surface of the luminaire housing 11 without the reflective sheet.

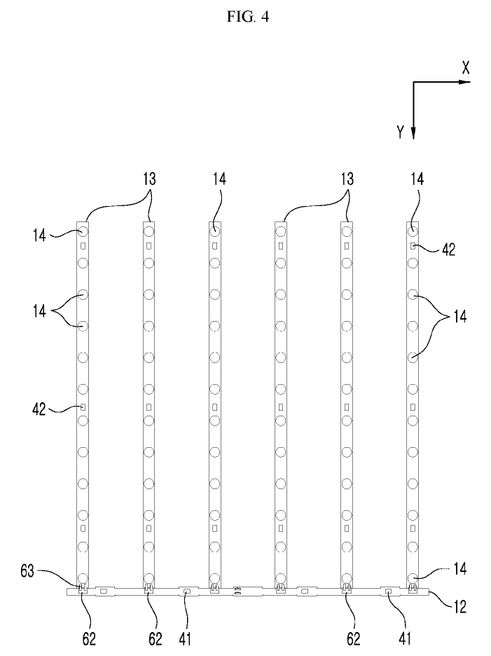

The connecting board 12 and the LED modules 13 may each have an elongated bar shape. Referring to FIGS. 4 and 5, the connecting board 12 may be disposed adjacent to one edge of the mounting surface 16 of the luminaire housing 11, and the plurality of LED modules 13 are arranged to extend in a direction substantially orthogonal to the connecting board 12.

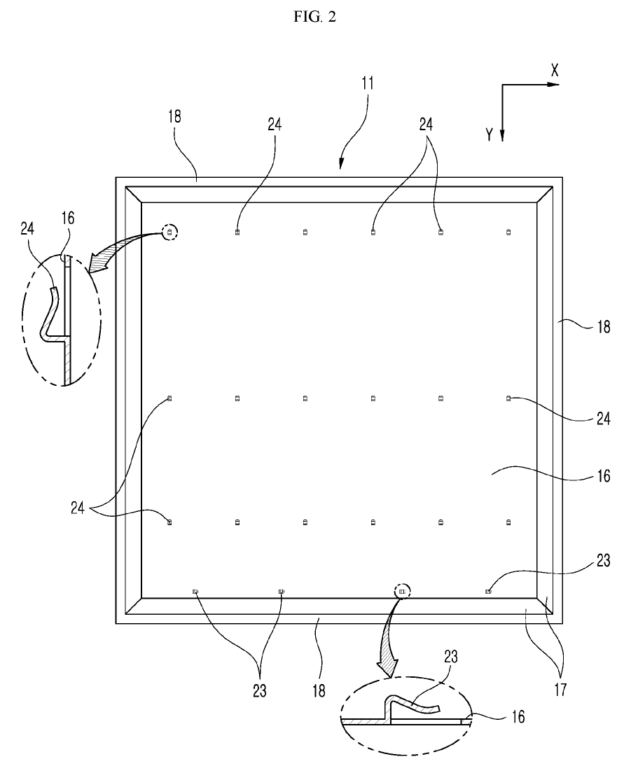

FIG. 2 illustrates a luminaire housing 11 of an LED lighting apparatus 10 according to an embodiment of the present invention. Referring to FIG. 2, the luminaire housing 11 includes an inclined sidewall portion 17 surrounding the mounting surface 16, and a support surface 18. The mounting surface 16 has a lower height than the sidewall portion 17, and accordingly, the luminaire housing 11 has an overall recessed shape in which an edge portion is higher and the mounting surface 16 is lower. The support surface 18 is formed to extend outward from an outer end of the sidewall portion 17. The support surface 18 extends substantially parallel to the mounting surface 16, and the inclined sidewall portion 17 obliquely connects an edge of the mounting surface 16 and an inner edge of the support surface 18. The sidewall portion 17 may perform a function of reflecting light emitted from the LED light sources 14, and a light diffusion plate 21 is fixed to the luminaire housing 11 in a state of being supported by the support surface 18. The light diffusion plate 21 covers the mounting surface 16 on which the LED modules 13 are disposed, and accordingly, light emitted from the LED light sources 14 travels after passing through the light diffusion plate 21.

Referring to FIG. 2, the mounting surface 16 of the luminaire housing 11 includes fastening elements for fastening the connecting board 12, namely hooks 23, and fastening elements for fastening the LED modules 13, namely hooks 24. The hooks 23 and 24 have a shape protruding from the mounting surface 16 and are formed so that the connecting board 12 and the LED modules 13 can be hooked and fixed thereto. The hooks 23 and 24 may be configured to be open at one side so that the connecting board 12 and the LED modules 13 can be inserted therein. The connecting board 12 and the LED modules 13 can be fixed to the luminaire housing 11 by being fitted between the hooks 23 and 24 and the mounting surface 16. For example, the hooks 23 and 24 may be formed by punching the luminaire housing 11. Meanwhile, in another embodiment, the hooks 23 and 24 may be formed of a material capable of elastic deformation, such as a synthetic resin or a metal.

The hooks 23 and 24 are each provided in plurality. The plurality of hooks 23 for fixing the connecting board 12 are arranged at intervals along a longitudinal direction of the connecting board 12, that is, along a horizontal direction in FIG. 2, and the plurality of hooks 24 for fixing the LED modules 13 are arranged at intervals along a longitudinal direction of the LED modules 13, that is, along a vertical direction in FIG. 2. In this case, the plurality of hooks 24 for fixing the LED modules 13 are arranged to form a plurality of rows corresponding to the number of the LED modules 13. Although the drawings illustratively show a case in which six LED modules 13 are provided, the number of the LED modules 13 is not limited thereto and may be variously changed.

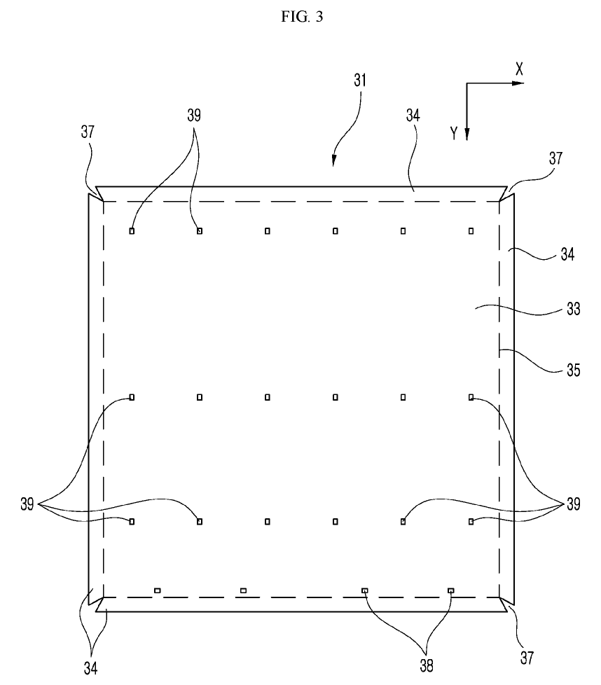

In an embodiment of the present invention, a reflective sheet 31 for light reflection is first placed on the luminaire housing 11, and then the connecting board 12 and the LED modules 13 are mounted. That is, the reflective sheet 31 as illustrated in FIG. 3 is first placed on the luminaire housing 11 as illustrated in FIG. 2, and thereafter, the connecting board 12 and the LED modules 13 are mounted so as to form the arrangement illustrated in FIG. 4. A state in which the connecting board 12 and the LED modules 13 are fixed on the reflective sheet 31 after the reflective sheet 31 is placed on the luminaire housing 11 is illustrated in FIG. 5.

The reflective sheet 31 is formed to cover the mounting surface 16 and the sidewall portion 17 of the luminaire housing 11. Although not separately illustrated in the drawings, in another embodiment, the reflective sheet may be formed to cover only the mounting surface of the luminaire housing. Referring to FIG. 3, the reflective sheet 31 includes a main portion 33 corresponding to the mounting surface 16 of the luminaire housing 11, and a side portion 34 connected to an outer side of the main portion 33 and corresponding to the sidewall portion 17 of the luminaire housing 11. The main portion 33 may be formed to have the same shape and size as the mounting surface 16 so as to entirely or at least partially cover the mounting surface 16 of the luminaire housing 11.

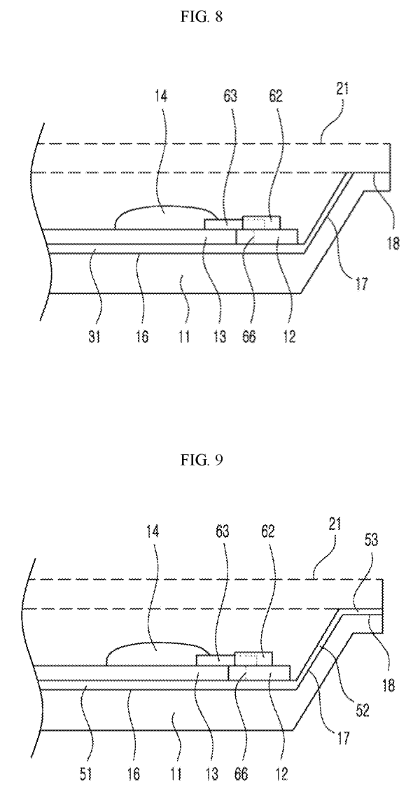

The side portion 34 is connected to an edge of the main portion 33 and is formed to entirely or at least partially cover the sidewall portion 17 of the luminaire housing 11. A folding score line 35 may be formed at a boundary between the main portion 33 and the side portion 34. For example, the score line 35 may be a pressed indentation formed by applying pressure or a perforated line formed in a dotted pattern, and is formed so that the main portion 33 and the side portion 34 can be easily folded along the score line 35 in accordance with an angle between the mounting surface 16 and the sidewall portion 17 of the luminaire housing 11. In FIG. 3, the score line 35 is illustrated by a dotted line. In addition, the reflective sheet 31 includes cut portions 37 formed at four corner portions, and the side portion 34 can be folded with respect to the main portion 33 by the cut portions 37. As illustrated in an enlarged portion A of FIG. 5 and in FIG. 8, an outer end 36 of the side portion 34 may be formed to be positioned at an outer end of the sidewall portion 17.

In another embodiment, referring to FIG. 9, an outer end of a side portion 52 of a reflective sheet 51 may be formed to be positioned outside the sidewall portion 17. That is, as illustrated in FIG. 9, an edge portion 53 of the reflective sheet 51 is positioned on the support surface 18 of the luminaire housing 11 and is fitted between the light diffusion plate 21 and the support surface 18. Accordingly, when the light diffusion plate 21 is assembled to the luminaire housing 11, the edge portion 53 of the reflective sheet 51 can be fixed by being sandwiched between the support surface 18 and the light diffusion plate 21. Since the edge portion 53 of the reflective sheet 51 is fixed by being sandwiched between the support surface 18 of the luminaire housing 11 and the light diffusion plate 21, a separate fixing member and an assembly process for fixing the reflective sheet 51 can be omitted, thereby facilitating assembly and reducing the number of the assembly processes.

The reflective sheet 31 includes escape holes 38 and 39 formed at positions corresponding to the hooks 23 and 24. In a state in which the reflective sheet 31 is placed on the luminaire housing 11, the hooks 23 and 24 are exposed by protruding upward through the escape holes 38 and 39, respectively. Unlike the embodiment of the present invention, in general, a reflective sheet is installed above LED modules. In such a case, a greater number of holes must be formed in the reflective sheet to avoid LED light sources, and an adhesive or a separate fixing structure is required to fix the reflective sheet. According to the present invention, by installing the reflective sheet below the LED modules, the number of perforated holes can be significantly reduced, and fixing of the reflective sheet is achieved incidentally during assembly of the LED modules, optical members, and the like, thereby reducing manufacturing cost and assembly cost of the reflective sheet.

As illustrated in FIG. 3, considering that an assembly direction of the connecting board 12 and an assembly direction of the LED modules 13 form a predetermined angle, for example, an angle of 90 degrees, the escape holes 38 and 39 are also formed to extend in corresponding directions so as to form a predetermined angle. Because the directions of the escape holes 38 and 39 are different as described above, when the LED modules 13 are assembled by sliding movement while the reflective sheet 31 is placed on the luminaire housing 11, displacement of the reflective sheet 31 can be prevented. When the connecting board 12 is assembled by sliding movement, the escape hole 39 for assembly of the LED modules 13 functions to prevent displacement, and when the LED modules 13 are assembled by sliding movement, the escape hole 38 for assembly of the connecting board 12 functions to prevent displacement.

Referring to FIG. 5, in a state in which the reflective sheet 31 is placed on the luminaire housing 11, the main portion 33 of the reflective sheet 31 is in close contact with the mounting surface 16 of the luminaire housing 11, and the side portion 34 is folded along the score line 35 to be in close contact with the sidewall portion 17 of the luminaire housing 11. Accordingly, all or most of the mounting surface 16 and the sidewall portion 17 of the luminaire housing 11, which may affect light reflection, are covered by the reflective sheet 31. At this time, the hooks 23 for fixing the connecting board 12 and the hooks 24 for fixing the LED modules 13 are respectively exposed to the outside of the main portion 33 of the reflective sheet 31 through the escape holes 38 and 39.

As described above, after the reflective sheet 31 is placed on the luminaire housing 11, the connecting board 12 and the LED modules 13 are sequentially assembled thereon. As mentioned above, the connecting board 12 and the LED modules 13 are assembled to form an arrangement as illustrated in FIG. 4, and a state in which the connecting board 12 and the LED modules 13 are assembled to the luminaire housing 11 on which the reflective sheet 31 is placed is illustrated in FIG. 5.

The connecting board 12 includes insertion holes 41 into which the hooks 23 are inserted for fastening with the hooks 23, and the LED modules 13 include insertion holes 42 into which the hooks 24 are inserted for fastening with the hooks 24. With distal ends of the hooks 23 inserted through the insertion holes 41 and the connecting board 12 placed on the reflective sheet 31, the connecting board 12 is slid in a fastening direction, that is, in a leftward direction in FIG. 5, to be fastened to the hooks 23. Similarly, with distal ends of the hooks 24 inserted through the insertion holes 42 and the LED modules 13 placed on the reflective sheet 31, the LED modules 13 are slid in a fastening direction, that is, in a downward direction in FIG. 5, to be fastened to the hooks 24. Accordingly, as illustrated in enlarged portions B and C of FIG. 5, the connecting board 12 and the LED modules 13 are fixed to the luminaire housing 11 by the hooks 23 and 24 with the reflective sheet 31 interposed therebetween.

As described above, the LED modules 13 may be assembled after the connecting board 12 is assembled first. When the LED modules 13 are assembled to the luminaire housing 11 by fastening with the hooks 24, electrical connection between the LED modules 13 and the connecting board 12, that is, electrical connection between the LED modules 13 and the connecting board 12 through the connector 15, may be configured to be established simultaneously. That is, in a state in which the connecting board 12 is assembled to the luminaire housing 11 first, with the hooks 24 passing through the insertion holes 42, the LED modules 13 are placed on the reflective sheet 31, and when the LED modules 13 are slid in an assembly direction, that is, in a downward direction in FIG. 5, the LED modules 13 are fitted to the hooks 24 and mechanically fixed to the luminaire housing 11, while at the same time, a female connector and a male connector constituting the connector 15 are engaged with each other, thereby establishing electrical connection between the LED modules 13 and the connecting board 12.

As described above, by sequentially assembling the connecting board 12 and the LED modules 13 through the hooks 23 and 24 protruding outward from the reflective sheet 31 in a state in which the reflective sheet 31 is placed on the luminaire housing 11, the luminaire housing 11, the reflective sheet 31, the connecting board 12, and the LED modules 13 are assembled so as to be fixed to each other. At this time, as illustrated in enlarged portions B and C of FIG. 5, the reflective sheet 31 can be fixed by being interposed between the mounting surface 16 of the luminaire housing 11 and the connecting board 12 and the LED modules 13. Accordingly, all or most of the mounting surface 16 and the sidewall portion 17 of the luminaire housing 11, which affect light reflection except for the connecting board 12 and the LED modules 13, are covered by the reflective sheet 31, thereby improving light efficiency of the LED lighting apparatus and eliminating dark regions to enhance light uniformity. In addition, while it is generally required to perform a painting process with a high-reflectance coating after forming the luminaire housing in order to improve light efficiency, by applying the reflective sheet installation structure as described above, which requires a significantly reduced number of perforation holes and is simple to install, light efficiency of the luminaire can be enhanced without an additional painting process, while using low-cost materials such as pre-painted steel or galvanized steel.

According to a method of assembling the LED lighting apparatus according to the above-described embodiment, the reflective sheet 31 is first placed on the luminaire housing 11, and the connecting board 12 and the LED modules 13 are sequentially assembled to the hooks 23 and 24 exposed through the escape holes 38 and 39 of the reflective sheet 31. In addition, after the connecting board 12 is mechanically fixed to the luminaire housing 11, the LED modules 13 are fixed, and when the LED modules 13 are fixed to the luminaire housing 11, electrical connection between the LED modules 13 and the connecting board 12 is simultaneously established.

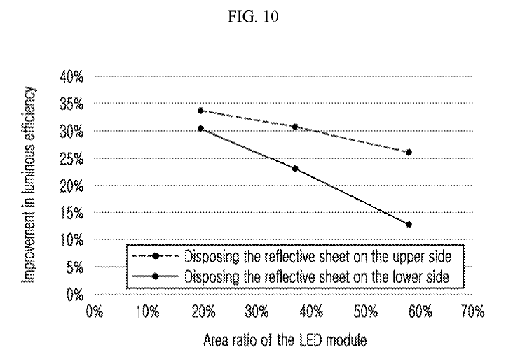

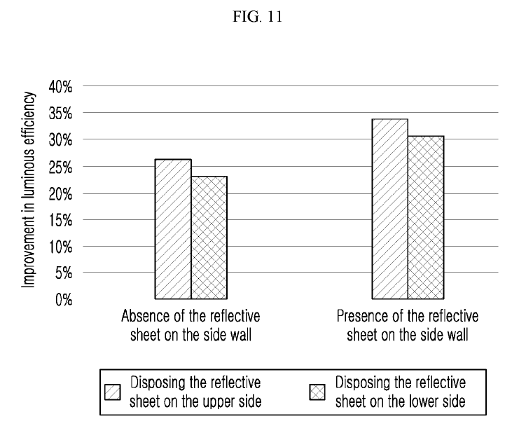

FIGS. 10 and 11 illustrate degrees of improvement in light efficiency of a luminaire when a reflective sheet is disposed above and below LED modules. First, FIG. 10 comparatively illustrates a degree of improvement in luminous efficiency of a luminaire between a conventional structure in which a reflective sheet is disposed above LED modules and a structure of the present invention in which a reflective sheet is disposed below LED modules. From the viewpoint of luminous efficiency improvement, disposing the reflective sheet above the LED modules is effective, whereas from the viewpoint of assemblability, disposing the reflective sheet below the LED modules is effective. In the experimental example of FIG. 10, improvement in luminous efficiency was measured for three cases in which an area ratio of the LED modules was 19.5%, 36.9%, and 57.9%. Referring to the results of FIG. 10, as the area ratio of the LED modules increases, disposing the reflective sheet below the LED modules becomes increasingly disadvantageous in terms of light efficiency improvement. In particular, when the area ratio of the LED modules reaches about 60 percent, the luminous efficiency improvement obtained by disposing the reflective sheet below the LED modules decreases to about half of that obtained by disposing the reflective sheet above the LED modules. In consideration of this, in an embodiment of the present invention, a ratio of an area of the LED modules to an area of the mounting surface of the luminaire housing is set to be smaller than a predetermined value, for example, a value falling within a range of 30% to 50%, and the reflective sheet 31 is installed on the luminaire housing 11 first, and then the LED modules 13 are installed thereon. When the area ratio is small as described above, it is preferable to dispose the reflective sheet below the connecting board and the LED modules, whereby assembly and fixing can be simplified. When the LED modules are installed first and the reflective sheet is placed thereon, the reflective sheet must have a large number of escape holes to expose all LED light sources of the LED modules, and an adhesive layer or separate fixing components are required to attach the reflective sheet to the LED modules. In the embodiment of the present invention, since the reflective sheet is installed on the mounting surface of the luminaire housing first and the LED modules are installed thereon, such problems can be overcome.

Meanwhile, FIG. 11 illustrates degrees of improvement in luminous efficiency when the reflective sheet 31 covers only the mounting surface 16 of the luminaire housing 11 and when the reflective sheet 31 covers both the mounting surface 16 and the inclined sidewall portion 17 of the luminaire housing 11, in cases where the reflective sheet is disposed above and below the LED modules, respectively. The two bar graphs shown on the left side of FIG. 11 illustrate degrees of improvement in luminous efficiency when the reflective sheet is disposed above and below the LED modules in a case where the reflective sheet is not present on the sidewall portion, and the two bar graphs shown on the right side of FIG. 11 illustrate degrees of improvement in luminous efficiency when the reflective sheet is disposed above and below the LED modules in a case where the reflective sheet is present on the sidewall portion. Referring to FIG. 11, it can be seen that light efficiency of the luminaire is further improved when the reflective sheet 31 covers not only the mounting surface 16 but also the sidewall portion 17 of the luminaire housing 11. For example, when the reflective sheet is disposed below the LED modules, light efficiency is improved by about 23% when the reflective sheet covers only the mounting surface of the luminaire housing, whereas light efficiency is improved by about 30% when the reflective sheet also covers the sidewall portion. That is, covering the sidewall portion with the reflective sheet provides an improvement in light efficiency that is approximately 1.3 times greater. In consideration of this, in an embodiment of the present invention, the reflective sheet 31 is disposed below the LED modules 13 and is configured to cover both the mounting surface 16 and the sidewall portion 17 of the luminaire housing 11, thereby enhancing the effect of improving light efficiency. In addition, this configuration is also helpful in improving dark regions that may occur at an edge of the optical member, that is, at the sidewall portion of the luminaire housing 11.

Meanwhile, the concept of disposing a reflective sheet below LED modules as described above may also be applied to a case in which a plurality of LED modules are installed in a luminaire housing without a connecting board. For example, when a ratio of an area of the LED modules to an area of a mounting surface of the luminaire housing is small as described above, the reflective sheet may be disposed below the plurality of LED modules and fixed through the LED modules. In this case, each LED module may be electrically connected to an external power source through a separate electrical connection means, for example, a wiring harness.

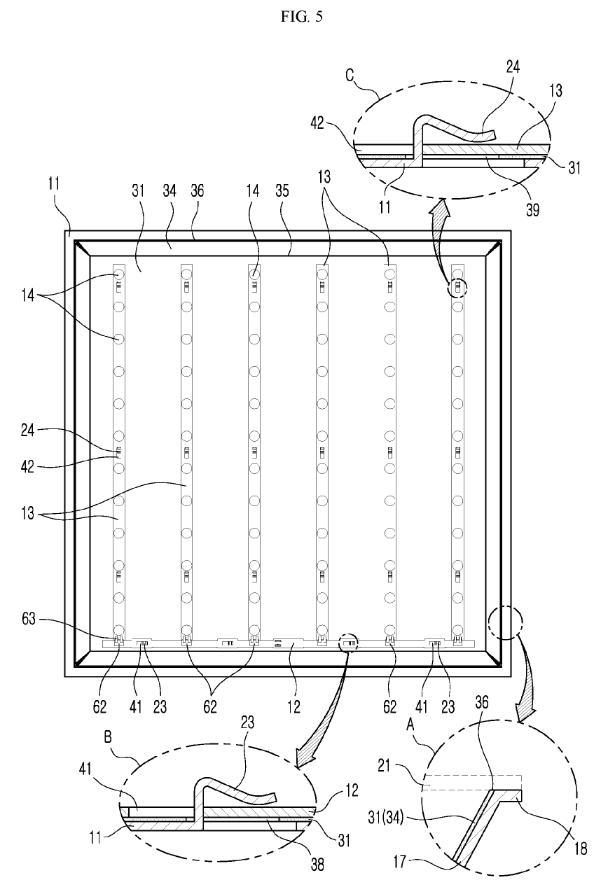

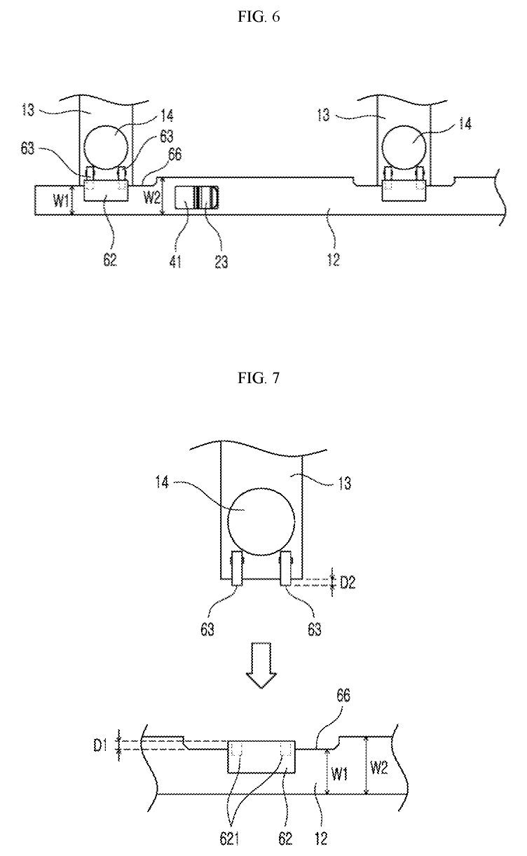

FIG. 6 is a view illustrating a coupled state of a connecting board 12 and an LED module 13 of an LED lighting apparatus according to an embodiment of the present invention, and FIG. 7 is a view illustrating a separated state of the connecting board 12 and the LED module 13 of the LED lighting apparatus according to an embodiment of the present invention. FIG. 8 is a cross-sectional view illustrating a state in which electrical connection between the connecting board 12 and the LED module 13 of the LED lighting apparatus according to an embodiment of the present invention is established. Referring to FIG. 8, the connecting board 12 and the LED module 13 that are electrically connected to each other through a connector 15 are arranged to be positioned on the same plane. Accordingly, a thickness of the lighting apparatus, that is, a height in a vertical direction in FIG. 8, can be minimized. In contrast, when the connecting board and the LED module are disposed on different planes, that is, at different heights in FIG. 8, problems such as an increase in an overall thickness of the lighting apparatus may occur. Specifically, when the connecting board is disposed below the LED module, the luminaire housing becomes thicker, and when the connecting board is disposed above the LED module, light emitted from nearby LED light sources, particularly from light-directing-angle lenses, may be blocked. In the present invention, such problems are solved by arranging the connecting board and the LED module on the same plane. Further, in this case, in order to overcome a problem in which an area available for disposition of the LED modules is reduced because the connecting board occupies space on the same plane, a portion of the connecting board where the connector is installed is formed to have a recessed shape toward an edge of the luminaire housing, thereby allowing the LED modules to be disposed as close as possible to the edge of the luminaire housing.

In an embodiment of the present invention, a structure is applied in which the connecting board 12 and the LED modules 13 are arranged on the same plane with respect to the mounting surface 16 of the luminaire housing 11, while allowing LED light sources 14 to be disposed as close as possible to an edge of the luminaire housing 11. To this end, as illustrated in FIGS. 6 and 7, in order to dispose the LED light sources 14 as close as possible to the edge of the luminaire housing 11, a width W1 of a portion in which a connector 62 provided on the connecting board 12 for electrical connection between the connecting board 12 and the LED modules 13 is disposed is formed to be smaller than a width W2 of a remaining portion, particularly a portion in which the hooks 23 are assembled, such that W1 is smaller than W2. In particular, in order to reduce the width W1 of the portion in which the connector 62 is disposed, one of side edges of the connecting board 12 that is farther from the edge of the luminaire housing 11, that is, an upper edge in FIG. 6, may have a recessed structure 66 that is recessed toward the edge of the luminaire housing 11. Accordingly, the LED modules 13 and the LED light sources 14 mounted thereon can be disposed closer to the edge of the luminaire housing 11, thereby suppressing occurrence of dark regions caused by an area occupied by the connecting board 12.

As illustrated in FIG. 6, a connector provided on the LED module 13 for electrical connection with the connecting board 12 may include two one-pole connectors 63 spaced apart from each other in a width direction of the LED module 13. For example, as illustrated in FIGS. 6 and 7, the two one-pole connectors 63 provided on the LED module 13 may be male connectors, and a connector provided on the connecting board 12 may be a two-pole female connector. The two-pole female connector 62 provided on the connecting board 12 may include insertion holes 621 into which the two one-pole male connectors 63 are respectively inserted. Electrical connection between the male connectors 63 and the female connector 62 may be established by moving the LED module 13 in a direction indicated by an arrow shown in FIG. 7.

In order to dispose the LED light sources 14 as close as possible to an edge of the luminaire housing 11, as illustrated in FIGS. 6 and 7, a recessed edge of the recessed structure 66 is formed to be further recessed than a distal end of the connector 62 provided on the connecting board 12, that is, further recessed than an upper end in FIGS. 6 and 7. Accordingly, a gap D1 is formed between the distal end of the connector 62 and the recessed edge of the recessed structure 66. The connector 63 provided on the LED module 13 is configured to protrude toward the connecting board 12 beyond an end of the LED module 13. That is, the recessed edge of the recessed structure 66 formed in the connecting board 12 is recessed toward the edge of the luminaire housing 11 by a predetermined length D1 relative to the distal end of the connector 62, and a distal end of the LED module 13 is disposed to be in close contact with the recessed edge of the recessed structure 66. In addition, a distal end of the connector 63 provided on the LED module 13 protrudes by a predetermined length D2 beyond the end of the LED module 13 facing the connecting board 12. Accordingly, the LED light source 14 located at an end of the LED module 13 can be disposed as close as possible to the edge of the luminaire housing 11, thereby suppressing occurrence of dark regions caused by an area occupied by the connecting board 12.

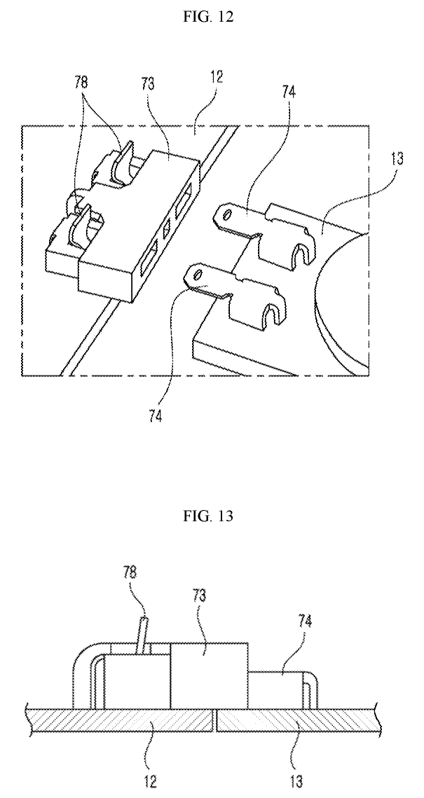

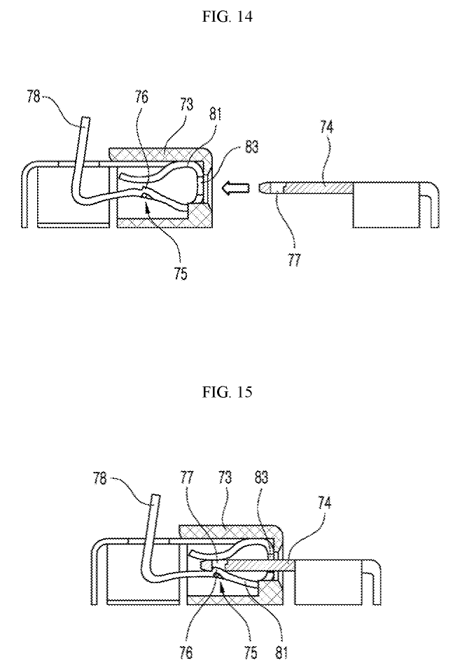

A connector structure according to another embodiment of the present invention will be described with reference to FIGS. 12 to 16. The connector structure for electrically connecting the connecting board 12 and the LED module 13 includes a first connector 73 provided on the connecting board 12 and a second connector 74 provided on the LED module 13, and electrical connection between the connecting board 12 and the LED module 13 is established by male–female coupling of the first and second connectors 73 and 74. FIG. 12 illustratively shows a case in which the first connector 73 is a two-pole connector and the second connector 74 includes two one-pole connectors. The structures of the first and second connectors 73 and 74 are not limited thereto and may be implemented as a two-pole connector or as two one-pole connectors.

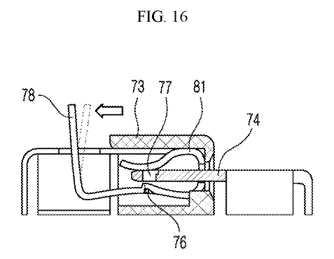

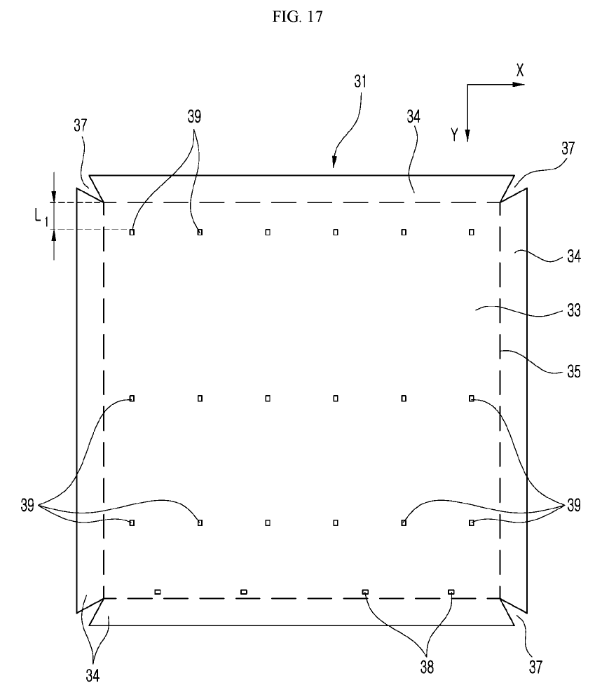

A locking structure 75 configured to switch between a locked state in which male–female coupling of the first and second connectors 73 and 74 is maintained and an unlocked state in which the male–female coupling of the first and second connectors 73 and 74 can be released is provided. For example, the locking structure 75 may include a latch 76 provided on the first connector 73 and a locking groove 77 provided on the second connector 74. The latch 76 is configured to be inserted into the locking groove 77 of the second connector 74 so as to prevent separation of the second connector 74. FIG. 15 illustrates the locked state, and FIG. 16 illustrates the unlocked state. The latch 76 may be formed on a conductive member 81 that forms an electrical connection by contacting the second connector 74. The connector member 81 may be disposed within a housing of the first connector 73 and includes a through hole 83 through which the second connector 74 passes. As illustrated in FIG. 15, when the first and second connectors 73 and 74 are coupled to each other, the second connector 74 passes through the through hole 83 and contacts the connector member 81, thereby establishing electrical connection. At this time, the latch 76 is maintained in a state of being inserted into the locking groove 77 of the second connector 74 by elastic restoring force of the connector member 81. The connector member 81 including the latch 76 is configured to have elasticity so as to be bendable and restorable, and a release member 78 is connected to the latch 76. When the release member 78 is pushed in a direction indicated by an arrow in FIG. 16, a portion on which the latch 76 is formed is deformed, thereby disengaging the latch 76 from the locking groove 77. When the latch 76 is disengaged from the locking groove 77, the second connector 74 can be separated from the first connector 73. By maintaining the coupled state of the first and second connectors 73 and 74 through the locking structure 75 as described above, separation of the first and second connectors 73 and 74 can be prevented during and after assembly.

Furthermore, by virtue of the locking structure 75 that enables maintaining or releasing a coupled state between the first and second connectors 73 and 74, assembly of the LED lighting apparatus is simplified and assembly labor is significantly reduced. A schematic assembly process of the LED lighting apparatus will now be described. First, the connecting board 12 is temporarily assembled on the mounting surface 16 of the luminaire housing 11 by using fastening elements, for example hooks 23 provided on the luminaire housing 11. At this time, the connecting board 12 is moved in a leftward direction in FIG. 5 so as to be engaged with the hooks 23. Thereafter, the LED module 13 is assembled on the mounting surface 16 of the luminaire housing 11 by using fastening elements, for example hooks 24 provided on the luminaire housing 11. At this time, the LED module 13 is moved in a direction orthogonal to an assembly direction of the connecting board 12, that is, downward in FIG. 5, so as to be engaged with the hooks 24. Simultaneously with the LED module 13 being mechanically fastened to the luminaire housing 11 by the hooks 24, the second connector 74 of the LED module 13 is coupled to the first connector 73 of the connecting board 12, thereby forming an electrical connection. At this time, the first connector 73 and the second connector 74 are configured such that a mechanical connection through the locking structure 75 is formed simultaneously with formation of the electrical connection. The mechanical connection between the first connector 73 and the second connector 74 blocks movement of the connecting board 12 in a direction in which the connecting board 12 would disengage from the hooks 23, that is, rightward in FIG. 5, thereby preventing separation of the connecting board 12 from the temporarily assembled state and completing final assembly. That is, due to constraint of the mechanical connection between the first connector 73 and the second connector 74 by the locking structure 75, the temporarily assembled connecting board 12 is restrained from separating from the luminaire housing 11, thereby achieving final assembly. Accordingly, separate fastening members such as screws or rivets for finally fixing the connecting board 12 to the luminaire housing 11 can be omitted, which leads to ease of assembly and reduction of assembly labor. In addition, since a constraint of mechanical connection between the LED module 13 and the connecting board 12 is formed by the locking structure 75, the mechanical connection between the first connector 73 and the second connector 74 blocks movement of the LED module 13 in a direction in which the LED module 13 would disengage from the hooks 24, that is, upward in FIG. 5. As described above, the LED module 13 can be mechanically connected to the luminaire housing 11 and the connecting board 12, and a constrained connection state can be formed, through a single assembly process. Such an overall constrained state can be achieved as the connecting board 12 and the LED module 13 meet each other in mutually orthogonal directions along the fastening elements and are locked by the connectors.

Meanwhile, in another example, the reflective sheet 31 may be installed on the mounting surface 16 of the luminaire housing 11, and the connecting board 12 and the LED modules 13 may be assembled thereon. In this case, after the reflective sheet 31 is first laid on the mounting surface 16 of the luminaire housing 11, the connecting board 12 and the LED modules 13 may be sequentially assembled through the process described above. Since the reflective sheet 31 is fixed to the luminaire housing 11 by the connecting board 12 and the LED modules 13, no separate process for fixing the reflective sheet 31 is required.

As described above, while the LED modules 13 and the connecting board 12 are coupled by the locking structure 75, the reflective sheet 31, the connecting board 12, and the LED modules 13 are finally fixed to the luminaire housing 11, and an outer end portion of the reflective sheet 31 positioned on the sidewall portion 17 of the luminaire housing 11 is fixed during assembly of the light diffusion plate 21. Accordingly, additional mechanical fixing such as adhesive bonding, screws, or rivets for fixing the reflective sheet 31, the connecting board 12, and the LED modules 13 is not required, and separate wiring process for electrically connecting the plurality of LED modules 13 can be eliminated.

Hereinafter, LED lighting apparatus according to other embodiments of the present invention will be described with reference to FIGS. 17 to 19. For components that are the same as those of the embodiments described above, the same reference numerals are used, and redundant descriptions thereof will be omitted.

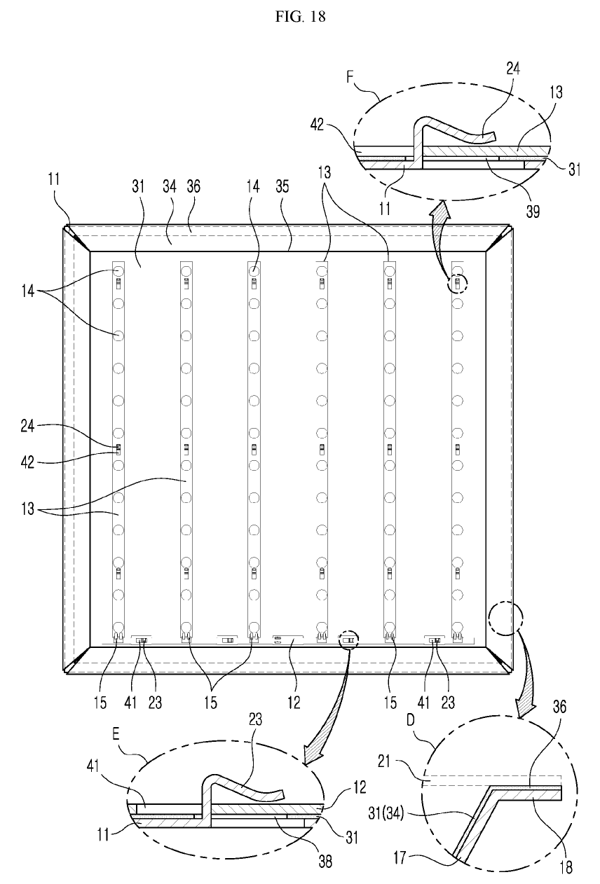

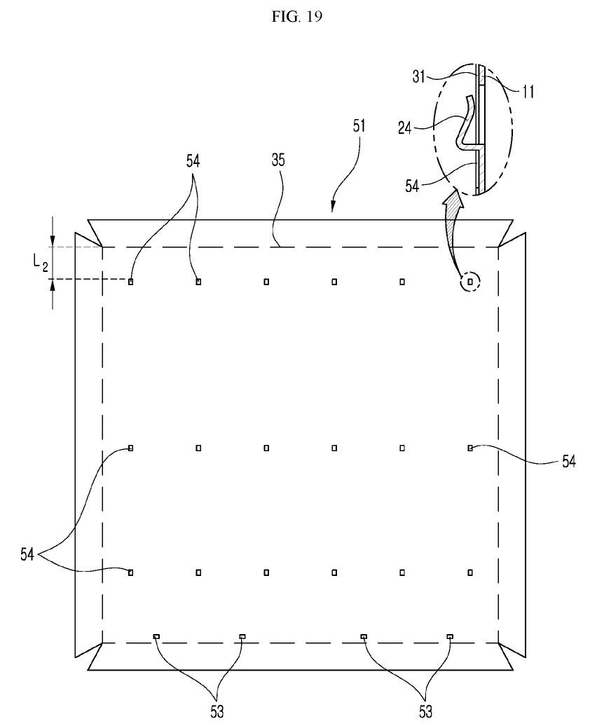

Referring to FIGS. 17 and 18, the reflective sheet 31 is formed to cover the mounting surface 16 and the sidewall portion 17 of the luminaire housing 11. Referring to FIG. 17, the reflective sheet 31 includes a main portion 33 corresponding to the mounting surface 16 of the luminaire housing 11, and a side portion 34 connected to an outer side of the main portion 33 and corresponding to the sidewall portion 17 of the luminaire housing 11. The main portion 33 may be formed to have the same shape and size as the mounting surface 16 so as to entirely or at least partially cover the mounting surface 16 of the luminaire housing 11. An outer portion 36 of the side portion 34 is formed to be positioned outside the sidewall portion 17, and as illustrated in an enlarged portion D of FIG. 18, the outer portion 36 is formed to be pressed by an edge portion of the light diffusion plate 21 coupled to the luminaire housing 11. Accordingly, the reflective sheet 31 can be firmly fixed between the luminaire housing 11 and the light diffusion plate 21.

As in the embodiments described above, the connecting board 12 and the LED modules 13 are fixed to the luminaire housing 11 by the hooks 23 and 24 with the reflective sheet 31 interposed therebetween. Accordingly, as illustrated in enlarged portions E and F of FIG. 18, the connecting board 12 and the LED modules 13 are fixed to the luminaire housing 11 by the hooks 23 and 24 in a state in which the reflective sheet 31 is interposed therebetween.

FIG. 19 illustrates a reflective sheet 51 according to another embodiment of the present invention. In this embodiment, in order to prevent the reflective sheet 51 from being displaced together with the LED circuit board 13 when the LED circuit board 13 is slid for assembly, the reflective sheet 51 is configured such that movement of the reflective sheet 51 in an assembly direction of the LED circuit board 13, that is, a downward direction in FIG. 19, is blocked by contact with the hooks 24. To this end, among escape holes 53 and 54 of the reflective sheet 51, a position of the escape hole 54 into which the hook 24 for assembly with the LED circuit board 13 is inserted is formed to be located lower than that in the embodiment described above. That is, a distance L2 between the escape hole 54 illustrated in FIG. 19 and the crease line 35 is formed to be greater than a distance L1 between the escape hole 39 illustrated in FIG. 17 and the crease line 35. After the hook 24 is inserted into the escape hole 54, the reflective sheet 51 is slid in the assembly direction of the LED circuit board 13, that is, downward in FIG. 19, so that the reflective sheet 51 is fitted onto the hook 24, and in this state, as illustrated in a dotted circle in FIG. 19, an upper boundary of the escape hole 54 comes into close contact with the hook 24, thereby blocking further downward movement of the reflective sheet 51. Accordingly, when the LED circuit board 13 is slid to be engaged with the hook 24 in a state in which the reflective sheet 51 is laid, the reflective sheet 51 can be prevented from being displaced together therewith. At this time, since the escape holes 53 for assembly of the connecting board 12 are arranged to form an angle of 90 degrees, the escape holes 53 into which the hooks 23 for assembly of the connecting board 12 are inserted may be formed at the same positions as those in the embodiment described above so as to allow assembly of the reflective sheet 51.

Although the embodiments of the present invention have been described above, the scope of the present invention is not limited thereto, and various modifications and improvements made by a person skilled in the art using the basic concept of the present invention as defined in the following claims also fall within the scope of the present invention.

What is claimed is:

1. An LED lighting apparatus, comprising:
a luminaire housing forming a mounting surface;
a connecting board configured to be electrically connected to an external power source and fixed to the luminaire housing; and
a plurality of LED modules fixed to the luminaire housing in a state of being electrically connected to the connecting board, each of the LED modules including an LED light source,
wherein the connecting board and the LED modules are disposed on the same plane with respect to the mounting surface.

2. The LED lighting apparatus of claim 1, wherein the connecting board is arranged near an edge of the luminaire housing, and wherein the LED modules are arranged to extend in a direction orthogonal to a longitudinal direction of the connecting board.

3. The LED lighting apparatus of claim 1, wherein the LED modules are configured such that, in a state in which the connecting board is fixed to the luminaire housing, the LED modules move in a direction orthogonal to the connecting board so that electrical connection with the connecting board and mechanical connection with the luminaire housing are simultaneously established.

4. The LED lighting apparatus of claim 1, wherein the connecting board is fixed to the luminaire housing by fastening elements provided on the luminaire housing,
wherein the connecting board comprises a first connector for electrical connection with the LED module,
wherein the LED module comprises a second connector electrically connectable to the first connector, and
wherein the connecting board is configured such that a width of a first portion in which the first connector is disposed is smaller than a width of a second portion coupled to the fastening elements.

5. The LED lighting apparatus of claim 1, wherein the first portion is formed as a recessed structure in which a side opposite to an edge of the luminaire housing is recessed toward the edge of the luminaire housing.

6. The LED lighting apparatus of claim 5, wherein a recessed edge of the recessed structure is formed to be further recessed toward an edge of the luminaire housing than a distal end of the first connector.

7. The LED lighting apparatus of claim 1, wherein the connecting board comprises a first connector for electrical connection with the LED module,
wherein the LED module comprises a second connector capable of being electrically connected to the first connector, and
wherein the second connector is composed of two one-pole connectors spaced apart from each other in a width direction of the LED module.

8. The LED lighting apparatus of claim 1, wherein the luminaire housing comprises one or more first fastening elements for fixing the connecting board, and one or more second fastening elements for fixing the LED modules,
wherein the connecting board is fixed to the luminaire housing by being fastened to the first fastening elements, and
wherein the LED modules are fixed to the luminaire housing by being fastened to the second fastening elements.

9. The LED lighting apparatus of claim 8, wherein the connecting board is mechanically connected to the luminaire housing by being engaged with the first fastening element through sliding on the mounting surface, and
wherein the LED module is mechanically connected to the luminaire housing by being engaged with the second fastening element through sliding on the mounting surface.

10. The LED lighting apparatus of claim 9, wherein a sliding direction for mechanical connection between the connecting board and the luminaire housing and a sliding direction for mechanical connection between the LED module and the luminaire housing are orthogonal to each other, and
wherein the LED lighting apparatus is configured such that, when the LED module is mechanically connected to the luminaire housing by sliding, mechanical connection between the LED module and the connecting board is simultaneously achieved.

11. The LED lighting apparatus of claim 1, further comprising a connector structure for forming electrical connection between the connecting board and the LED module, and
wherein the connector structure is configured such that mechanical connection is formed together with formation of the electrical connection and comprises a locking structure for locking and unlocking the mechanical connection.

12. The LED lighting apparatus of claim 11, wherein the connecting board and the LED module are configured to be respectively fastened to the luminaire housing by a first fastening element and a second fastening element,
wherein the LED module is configured such that a mechanical connection by the connector structure is formed when the LED module is assembled to the luminaire housing by the second fastening element,
wherein the LED module assembled to the luminaire housing by the second fastening element is configured to be prevented from being detached from the luminaire housing by the mechanical connection of the connector structure, and
wherein the connecting board temporarily assembled to the luminaire housing by the first fastening element is configured to be prevented from being detached from the luminaire housing by the mechanical connection of the connector structure, such that the connecting board is finally fixed to the luminaire housing.

13. The LED lighting apparatus of claim 11,
wherein the connector structure comprises a first connector provided on the connecting board, and a second connector provided on the LED module,
and wherein the locking structure comprises:
a latch provided on one of the first connector and the second connector;
a locking groove provided on the other one of the first connector and the second connector and configured to allow the latch to be inserted therein; and
a release member connected to the latch and configured to be deformable by an external force such that the latch can be disengaged from the locking groove.

14. The LED lighting apparatus of claim 13, wherein the latch is configured such that, when no external force is applied, the latch is inserted into the locking groove by elastic restoring force so that a locked state is maintained, and when an external force is applied to the release member, the latch is disengaged from the locking groove by deformation so as to be brought into an unlocked state.

15. The LED lighting apparatus of claim 1, further comprising a reflective sheet that covers the mounting surface,
wherein the LED module is fixed to the luminaire housing in a state of being placed on the reflective sheet.

16. The LED lighting apparatus of claim 15, wherein the reflective sheet is pressed by the LED module to be fixed to the luminaire housing.

17. The LED lighting apparatus of claim 15, wherein the luminaire housing comprises an inclined sidewall portion disposed around a periphery of the mounting surface, and
wherein the reflective sheet is formed to cover the mounting surface and the inclined sidewall portion.

18. The LED lighting apparatus of claim 17, further comprising an optical member that is fastened to the luminaire housing and configured to adjust characteristics of light emitted from the LED modules, and
wherein an outer portion of the reflective sheet is configured such that an end thereof is pressed by the optical member and is fixed to the luminaire housing by the optical member when the optical member is assembled to the luminaire housing.

19. The LED lighting apparatus of claim 15, wherein a ratio of an area of the plurality of LED modules to the mounting surface is smaller than a predetermined ratio.

20. The LED lighting apparatus of claim 19, wherein the predetermined ratio falls within a range of 30% to 50%.
